(19) United States
(12) Patent Application Publication
(10) Pub. No.: US 2026/0324676 A1
(43) Pub. Date: Oct. 22, 2026

(54) FROZEN CONFECTION PRODUCT

(71) Applicant: Cargill, incorporated, Wayzata, MN (US)

(72) Inventor: Susen GOTTWALD, Frankfurt am Main (DE)

(73) Assignee: Cargill, incorporated, Wayzata, MN (US)

(21) Appl. No.: 19/486,925

(22) PCT Filed: May 29, 2024
(86) PCT No.: PCT/US2024/031375

§ 371 Date: Nov. 22, 2025

(30) Foreign Application Priority Data
Jun. 1, 2023 (EP) 23176709.6

(51) Int. Cl. A23G 9/32

(52) U.S. Cl. CPC A23G 9/327

(57) ABSTRACT

The present invention relates to a frozen confection product comprising 0.5 to 4 wt. % protein, 10 to 30 wt. % sweetener, 0.1 to 1 wt. % emulsifier, 0.1 to 1 wt. % stabilizer and 2 to 10 wt. % fat and the fat is consisting of interesterified lauric fat. It relates to a process for preparing the frozen confection product and the process is comprising, blending an interesterified fat with frozen confection product ingredients, and freezing the blend. It further relates to the use of interesterified lauric fat composition to improve sensory properties of a frozen confection product, and wherein the interesterified lauric fat is present in the frozen confection product in an amount of 2 to 10 wt. %.

### CROSS-REFERENCE TO RELATED APPLICATIONS

This application claims the benefit of European Patent Application No. 23176709.6, filed Jun. 1, 2023, which is hereby incorporated by reference in its entirety.

### FIELD OF THE INVENTION

The present invention relates to a frozen confection product, and a process for preparing the frozen confection product.

### BACKGROUND OF THE INVENTION

Frozen dairy dessert products such as ice cream, ice milk, milk shakes, sherbet, yogurt, sorbet and the aerated versions thereof, are popular due to their convenience, widespread availability, nutritive value and appealing forms, flavors, and colors.

A weight conscious society has further popularized non-fat and low-fat preparations, while consumer expectations such as flavor, appearance, and in particular the physical properties of aerated frozen dessert products remain high priority.

The combination of rigid consumer acceptance criteria, regulatory standards and the complex nature of the interactions which produce an acceptable frozen dessert product, make it difficult to formulate an aerated frozen dessert having improved characteristics, containing only natural components and ingredients.

The foregoing factors are also true for frozen dairy dessert products such as ice cream bars, dessert bars, yogurt bars, ice milk bars, fudge pops and the like.

There is thus still a need in the industry for frozen confection product with similar preferably improved textural and/or sensorial properties. The present invention provides such a product.

### SUMMARY OF THE INVENTION

The present invention relates to a frozen confection product comprising protein, sweetener, emulsifier, stabilizer and fat and the fat is consisting of interesterified lauric fat.

It relates to a frozen confection product prepared by adding by adding interesterified lauric fat to frozen confection product ingredients.

It describes a process for preparing the frozen confection product of the present invention and the process is comprising:
Blending interesterified lauric fat with frozen confection product ingredients different from fat,
Freezing the blend.

It further relates to the use of interesterified lauric fat to improve sensory properties of a frozen confection product.

### DETAILED DESCRIPTION

The present invention relates to a frozen confection product comprising protein, sweetener, emulsifier, stabilizer and fat and the fat is consisting of interesterified lauric fat.

“Frozen,” as used herein, denotes that the product is solidified under freezing conditions to a hardpack or pumpable consistency, or a soft, semi-fluid, or spoonable consistency.

The protein used in the present invention is obtained from a source containing milk protein. Milk protein may be derived from any suitable milk source, as for example, skim milk, condensed skim milk, ultrafiltered skim milk concentrate or retentate, milk powder, lactose-reduced nonfat milk, milk protein isolate, and the like.

Without being bound by any theory, it may be that a source of milk protein is acting as a source of high molecular weight compounds to provide body and texture to the frozen confection product and decrease sensitivity to temperature fluctuations and increase stability to heat shock of the frozen confection product. Primarily, milk proteins include casein and whey protein. It is preferred that the milk protein component has a casein to whey protein ratio according to that found naturally in skim milk, or about 4:1.

The sweetener used in the present invention can be any sweetener that is commonly used in frozen confection product. It may be a natural or artificial sweetening agent. Stabilizer and emulsifier have been used in an attempt to improve the heat shock stability, appearance and shelf life of the frozen confection product. Examples of stabilizers which have traditionally been used in frozen confection product such as ice cream include gum acacia, guar gum, locust bean gum, carob bean gum, carrageenan, and the like. Often microcrystalline cellulose and carboxymethylcellulose are used in combination with the previously mentioned gums to maximize their functional effectiveness, to reduce the degree of ice crystal growth by influencing viscosity and other rheological properties, thus limiting the mobility of water in the unfrozen aqueous portion.

Emulsifiers are the ones that are commonly used in frozen confection product and help providing stability by facilitating the formation of an interface between the aqueous phase and the fat phase. Examples of known emulsifiers include mono- and di-glycerides of saturated or unsaturated fatty acids (for example monoglyceryl palmitate), polyoxyethylene derivatives of hexahydric alcohols (usually sorbitol), glycols, glycol esters, polyglycerol esters, sorbitan esters, stearoyl lactylate, lactic acid esters, citric acid esters, acetylated monoglyceride, diacetyl tartaric acid esters, polyoxyethylene sorbitan esters, lecithin and egg yolk and mixtures thereof. Preferably the emulsifier is a mono-/di-glyceride of saturated fatty acids with a monoglyceride content of at least 40 percent.

Preferably the frozen confection product comprises at most 1 wt % (by weight of the product) emulsifier, at most 0.75 wt %, at most 0.5 wt %, at most 0.4 wt %, at most 0.3 wt %, at most 0.2 wt %, at most 0.1 wt %.

The interesterified lauric fat has a fatty acid moiety content with a carbon chain length of C12:0 of more than 20% based on total weight of the fatty acid moiety.

In an aspect of the invention, the fat composition has a solid fat content (SFC) at 10° C. of up to 75 wt. % and at 25° C. of more than 10 wt %.

Solid Fat Content (SFC) is the percentage of solids in fat at specified temperatures and is measured according to method well known in the art.

The method used for SFC measurement is DIN EN ISO 8292-1.

The interesterified lauric fat is a randomly interesterified fat, which is a triglyceride composition wherein the fatty acids that are bound as acyl group in glycerides are randomly distributed over the glycerol backbone of the triglycerides. It can be obtained by means of a process of chemical or enzymatic interesterification.

A chemical interesterification is performed by using an acidic or basic catalyst, preferably a basic catalyst, such as, but not limited to, sodium methoxide or sodium ethoxide.

An enzymatic interesterification is obtained by means of a lipase enzyme. The lipase will generally be non-selective for the positions on the glyceride backbone in order to achieve the optimum random interesterification. Alternatively, selective lipases may be used, provided that the reaction conditions are such that no significant selectivity is observed, for example by running the reaction for extended periods of time. Suitable lipases include the lipases from Thermomyces lanuginosa, Rhizomucor miehei, Rhizopus delemar and Candida rugosa. Preferably, the lipase is suitable for use with food products.

The interesterified lauric fat may be characterized by the position of the saturated(S) and/or unsaturated (U) fatty acids bound onto the glycerol backbone of the triglycerides of the fat. Typically, the abbreviation S is used to denote a saturated fatty acid residue having 8 to 24 carbon atoms. The abbreviation U denotes an unsaturated fatty acid residue having 8 to 24 carbon atoms. Thus, a triglyceride having saturated fatty acids at the 1- and 3-positions and an unsaturated fatty acid at the 2-position of the glycerol backbone is denoted SUS. Likewise, a triglyceride having 2 saturated fatty acids at the 1- or 3-position and at the 2-position of the glycerol backbone and an unsaturated fatty acid at the remaining 1- or 3-position is denoted SSU. The ratio of SUS over SSU (SUS/SSU) of a fully randomized triglyceride composition is 0.5, whereas the SUS/SSU ratio of a non-randomized triglyceride is significantly higher than 1.

The triglyceride composition of the interesterified fat is characterized by a ratio of SUS over SSU (SUS/SSU) in a range of from 0.5 to 1.0, from 0.6 to 0.9, or from 0.7 to 0.8.

In one aspect of the invention, the interesterified fat is obtained by means of a chemical interesterification.

In the present invention, the interesterified fat is sourced from a lauric oil selected from coconut oil, coconut stearin, palm kernel oil, babassu oil, cohune oil, tacum oil and cuphea oil, hydrogenated coconut oil, palm kernel oil, fully hydrogenated palm kernel oil, palm kernel stearin, hydrogenated palm kernel stearin, palm kernel olein, fully hydrogenated palm kernel olein, or a mixture of two or more thereof.

In one aspect the interesterified fat is interesterified coconut oil.

In an aspect of the invention, the frozen confection product is comprising the interesterified lauric fat in an amount of 2 to 10 wt % fat composition based on the weight of the frozen confection product.

In an aspect of the invention, the frozen confection product is comprising:
2.0 to 10 wt % fat
0.5 to 4 wt % protein
10 to 30% sweetener
0.1 to 1 wt % emulsifier, and
0.1 to 1 wt % stabilizer, based on the weight of the frozen confection product, and
   wherein the fat is consisting of interesterified lauric fat. The balance (to 100%) is water.

In an aspect, the frozen confection product of the present invention is prepared by adding an interesterified lauric fat to frozen confection product ingredients (other than fat). The frozen confection product ingredients are the ingredients mentioned before, such as protein, sweetener, emulsifier, stabilizer, and water.

The frozen confection product of the present invention is selected from ice cream, frozen custard, ice milk, frozen yogurt, sherbet, water ices, mellorine, frozen dairy desserts for special dietary purposes, dairy dessert bars, frozen mousse desserts.

In an aspect of the invention, the frozen confection product of the present invention is selected from ice cream, frozen custard, ice milk, frozen yogurt, sherbet, mellorine, dairy dessert bars, frozen mousse desserts.

In one aspect of the invention, the frozen confection product is ice cream or mellorine.

Ice cream has the highest fat content, ranging from 5% percent, up to 16% for so-called premium ice cream.

Frozen custard, or French ice cream, is basically the same formula as ice cream but contains added eggs or egg solids (usually 1.4 percent by weight).

Ice milk may be more commonly called “light” or “reduced-fat” ice cream. It contains between 2 and 7 percent fat and at least 11 percent total milk solids.

Frozen yogurt is a cultured frozen product containing the same ingredients as ice cream. It must contain at least 3.25 percent milk fat and 8.25 percent milk solids.

Low-fat frozen yogurt contains between 0.5 and 2 percent milk fat. Frozen yogurts should always contain live cultures of bacteria.

Sherbets contain relatively small quantities of milk products. Most standards require between 1 and 2 percent milk fat and between 2 and 5 percent total milk solids. Sherbet contains considerably more sugar and less air than ice cream (the target overrun is 30 to 40 percent), and therefore it is heavier and often contains more calories per serving.

Water ices are similar to sherbet, but they contain no milk solids and have a target overrun of 20 to 30 percent.

Imitation ice cream, known as mellorine, is made in some parts of the United States and other countries. It is made with vegetable oils instead of butterfat but uses dairy ingredients for the milk protein part.

Frozen dessert bar may be an ice cream or mellorine filling, coated with chocolate and/or wafer. Frozen mousse is a frozen dessert of a frothy texture, made of sweetened and flavored whipped cream, sometimes with the addition of egg yolks and gelatine. Mousse differs from ice cream in being beaten before—not during—the freezing process.

A typical way to access the quality of frozen confection product is done by measuring its overrun. Overrun refers to the degree of expansion resulting from the amount of air incorporated into the product during the freezing process. An overrun of around 100% indicates that air makes up 50% of its volume.

Overrun is defined by the formula:

overrun (%)=(weight of mix−weight of aerated product)/(weight of aerated product)×100,

where the weights refer to a fixed volume of mix or product. Overrun is measured at atmospheric pressure.

The frozen confection product may be aerated or unaerated. By unaerated is meant an overrun of less than 20%, preferably less than 10%. An unaerated frozen confection is not subjected to deliberate steps such as whipping to increase the gas content. Preferably the frozen confection product is aerated. Aerated frozen confection products have an overrun of more than 20%, preferably more than 50%, or more than 75%. Preferably the frozen confection product has an overrun of less than 200%, less than 150%, or less than 120%.

The target overrun for ice cream, ice milk, and frozen yogurt may be 65 to 100 percent. Premium ice creams may be as low as 20 percent overrun, while soft ice creams are in the 30 to 50 percent range.

The present invention further relates to a process for preparing the frozen confection product of the invention and the process is comprising:
Blending interesterified lauric fat with frozen confection product ingredients different from fat,
Freezing the blend.

Usually, the first step in ice cream making is formulating a suitable mix. The mix is composed of the frozen confection product ingredients such as protein, sweetener, emulsifier, stabilizer and fat composition. As mentioned before, the stabilizers and emulsifiers are added in small amounts to help prevent formation of ice crystals, particularly during temperature fluctuations in storage.

The ice cream mix is heated to a temperature of at least 79° C. The heated mix is typically homogenized in order to assure a smoother body and texture. Homogenizing also prevents churning (i.e., separating out of fat granules) of the mix in the freezer and increases the viscosity.

After homogenization, the hot mix is quickly cooled to below 5° C. The mix must age at this temperature for at least four hours to allow the fat to solidify and fat globules to clump.

This aging process results in quicker freezing and a smoother product.

The next step, freezing the mix, to freeze the product partially and, at the same time, incorporate air.

Semifrozen ice cream leaves the freezer at a temperature between −9 and −5° C. (16 and 23° F.). It is placed in a suitable container and conveyed to a blast freezer, where temperatures are in the range of −29 to −34° C. While in this room, the ice cream continues to freeze without agitation. Rapid freezing at this stage prevents the formation of large ice crystals and favours a smooth body and texture. The length of time in the hardening room depends on the size of the package, but usually 4 to 12 hours are required to bring the internal ice cream temperature to −18° C. or below. In larger manufacturing plants, final freezing takes place in a hardening tunnel, where packages are automatically conveyed on a continuous belt to the final storage area.

Furthermore, the present invention relates to the frozen confection product obtainable by the process of the current invention.

The present invention further relates to a use of interesterified lauric fat to improve sensory properties of a frozen confection product.

In one aspect, it relates to the use wherein the interesterified lauric fat is present in the frozen confection product in an amount of 2 to 10 wt % based on the weight of the frozen confection product.

In an aspect of the invention, the fat composition has a content of the C12:0 fatty acid moiety of more than 20%.

It has been found that the frozen confection product according to the present invention, has better scores for Ice cream Taste, Dairy Notes, Fullness and Balance, compared with frozen confection products using coconut oil as the fat present in the frozen confection product.

The frozen confection product according to the present invention showed for the Texture-Mouthfeel Descriptors better results on Density and Viscosity/Thickness which contributes to Fullness of the Ice cream Product.

No Off-& Aftertaste or afterfeel attributes are detected for the frozen confection product according to the present invention.

### CLAUSES

1. A frozen confection comprising protein, sweetener, emulsifier, stabilizer and fat and the fat is consisting of interesterified lauric fat.
2. The frozen confection product according to clause 1 wherein the fat has a fatty acid moiety content with a carbon chain length of C12:0 of more than 20% based on total weight of the fatty acid moiety.
3. The frozen confection product according to clause 1 or 2 wherein the fat has a fatty acid moiety content with a carbon chain length of C16:0 of less than 15% based on total weight of the fatty acid moiety.
4. The frozen confection product according to anyone of the preceding clauses wherein the fat has a solid fat content at 10° C. of up to 75 wt. % and at 25° C. of more than 10 wt %.
5. The frozen confection product according to anyone of the preceding clauses wherein the fat is present in an amount of 2 to 10 wt % based on the weight of the frozen confection product.
6. The frozen confection product according to anyone of the preceding clauses wherein the frozen confection product is comprising
   2.0 to 10 wt % fat
   0.5 to 4 wt % protein
   10 to 30% sweetener
   0.1 to 1 wt % emulsifier, and
   0.1 to 1 wt % stabilizer, based on the weight of the frozen confection product, and
   wherein the fat is consisting of an interesterified lauric fat.
7. The frozen confection product according to anyone of the preceding clauses wherein the frozen confection product is comprising
   2.0 to 10 wt % fat
   0.5 to 4 wt % protein
   10 to 30% sweetener
   0.1 to 1 wt % emulsifier, and
   0.1 to 1 wt % stabilizer,
   54 to 76.8% water based on the weight of the frozen confection product, and
   wherein the fat is consisting of an interesterified lauric fat.
8. The frozen confection product according to anyone of the preceding clauses wherein the interesterified fat is characterized by a ratio of SUS over SSU (SUS/SSU) in a range of from 0.5 to 1.0, from 0.6 to 0.9, or from 0.7 to 0.8.
9. The frozen confection product according to anyone of the preceding clauses wherein the lauric fat of the interesterified fat is selected from coconut oil, coconut stearin, palm kernel oil, babassu oil, cohune oil, tacum oil and cuphea oil, hydrogenated coconut oil, palm kernel oil, fully hydrogenated palm kernel oil, palm kernel stearin, hydrogenated palm kernel stearin, palm kernel olein, fully hydrogenated palm kernel olein, or a mixture of two or more thereof.
10. The frozen confection product according to anyone of the preceding clauses wherein the interesterified lauric fat is interesterified coconut oil.
11. The frozen confection product according to anyone of the preceding clauses wherein the frozen confection product is selected from ice cream, frozen custard, ice milk, frozen yogurt, sherbet, water ices, mellorine, frozen dairy desserts for special dietary purposes, dairy dessert bars, frozen mousse desserts.
12. The frozen confection product according to anyone of the preceding clauses wherein the frozen confection product is ice cream or mellorine.
13. A frozen confection product prepared by adding an interesterified lauric fat to frozen confection product ingredients other than fat.
14. The frozen confection product according to clause 13 wherein the lauric fat of the interesterified fat is selected from coconut oil, coconut stearin, palm kernel oil, babassu oil, cohune oil, tacum oil and cuphea oil, hydrogenated coconut oil, palm kernel oil, fully hydrogenated palm kernel oil, palm kernel stearin, hydrogenated palm kernel stearin, palm kernel olein, fully hydrogenated palm kernel olein, or a mixture of two or more thereof.
15. The frozen confection product according to anyone of the clauses 13 to 14 wherein the interesterified fat is interesterified coconut oil.
16. The frozen confection product according to anyone of clauses 13 to 15 wherein the fat has a fatty acid moiety content with a carbon chain length of C12 of more than 20% based on total weight of the fatty acid moiety.
17. The frozen confection product according to anyone of clauses 13 to 16 wherein the fat has a solid fat content at 10° C. of up to 75 wt. % and at 25° C. of more than 10 wt %.
18. The frozen confection product according to anyone of clauses 13 to 17 wherein the frozen confection product is selected from ice cream, frozen custard, ice milk, frozen yogurt, sherbet, water ices, mellorine, frozen dairy desserts for special dietary purposes, dairy dessert bars, frozen mousse desserts.
19. The frozen confection product according to anyone of clauses 13 to 18 wherein the frozen confection product is ice cream or mellorine.
20. A process for preparing the frozen confection product according to anyone of clauses 1 to 19 and the process is comprising:
   Blending interesterified lauric fat with frozen confection product ingredients different from fat,
   Freezing the blend.
21. The process according to clause 20 wherein the interesterified lauric fat is present in an amount of 2 to 10 wt % based on the weight of the frozen confection product.
22. The process according to clause 20 or 21 wherein the frozen confection product is comprising
   2.0 to 10 wt % fat
   0.5 to 4 wt % protein
   10 to 30% sweetener
   0.1 to 1 wt % emulsifier, and
   0.1 to 1 wt % stabilizer, based on the weight of the frozen confection product, and
   wherein the fat is consisting of an interesterified lauric fat.
23. The process according to anyone of clauses 20 to 22 wherein the lauric fat of the interesterified fat is selected from coconut oil, coconut stearin, palm kernel oil, babassu oil, cohune oil, tacum oil and cuphea oil, hydrogenated coconut oil, palm kernel oil, fully hydrogenated palm kernel oil, palm kernel stearin, hydrogenated palm kernel stearin, palm kernel olein, fully hydrogenated palm kernel olein, or a mixture of two or more thereof.
24. The process according to anyone of clauses 20 to 23 wherein the interesterified fat is interesterified coconut oil.
25. The process according to anyone of clauses 20 to 24 wherein the fat has a fatty acid moiety content with a carbon chain length of C12:0 of more than 20% based on total weight of the fatty acid moiety.
26. The process according to anyone of clauses 20 to 25 wherein the fat has a solid fat content at 10° C. of up to 75 wt. % and at 25° C. of more than 10 wt %.
27. The process according to anyone of clauses 20 to 26 wherein the frozen confection product is selected from ice cream, frozen custard, ice milk, frozen yogurt, sherbet, and water ices, mellorine, frozen dairy desserts for special dietary purposes, dairy dessert bars.
28. The process according to anyone of clauses 20 to 27 wherein the frozen confection product is selected from ice cream and mellorine.
29. Use of interesterified lauric fat to improve sensory properties of a frozen confection product.
30. The use according to clause 29 wherein the interesterified lauric fat is present in the frozen confection product in an amount of 2 to 10 wt % based on the weight of the frozen confection product.
31. The use according to anyone of clauses 29 to 30 wherein the lauric fat of the interesterified fat is selected from coconut oil, coconut stearin, palm kernel oil, babassu oil, cohune oil, tacum oil and cuphea oil, hydrogenated coconut oil, palm kernel oil, fully hydrogenated palm kernel oil, palm kernel stearin, hydrogenated palm kernel stearin, palm kernel olein, fully hydrogenated palm kernel olein, or a mixture of two or more thereof.
32. The use according to anyone of clauses 29 to 31 wherein the interesterified fat is interesterified coconut oil.
33. The use according to anyone of clauses 29 to 32 wherein the fat has a fatty acid moiety content with a carbon chain length of C12:0 of more than 20% based on total weight of the fatty acid moiety.
34. The use according to anyone of clauses 29 to 33 wherein the fat has a solid fat content at 10° C. of up to 75 wt. % and at 25° C. of more than 10 wt %.
35. The use according to anyone of clauses 29 to 34 wherein the frozen confection product is selected from ice cream, frozen custard, ice milk, frozen yogurt, sherbet, and water ices, mellorine, frozen dairy desserts for special dietary purposes, dairy dessert bars.
36. The use according to anyone of clauses 29 to 35 wherein the frozen confection product is selected from ice cream and mellorine.

### EXAMPLES

### 1. The Fat

Refined coconut oil (Cargill) was used in the control experiment and, randomly interesterified coconut (Cargill) was used in the preparation of ice creams according to the invention.

The fatty acid profile and the solid fat content of the fat is shown in table 1.

TABLE 1
Composition of the fat compositions & fatty acid profile

| | |
|---|---|
| No 1 | No 2 |

Composition of the fat composition

| | | |
|---|---|---|
| Refined coconut oil | 100 | |
| Interesterified | | 100 |
| coconut oil | | |
| C12:0 | 45% | 45% |
| C16:0 | 11% | 11% |
| C18:0 | 3% | 3% |
| C16:0 + C18:0 | 14% | 14% |
| C12:0 + C16:0 | 56% | 56% |
| C12:0/C16:0 | 4.1 | 4.1 |
| Sum SAFA | 92% | 92% |

Solid fat content, % (DIN number 8292-1)

| | | |
|---|---|---|
| N10 | 81.0 | 71.9 |
| N15 | 66.6 | 60.4 |
| N20 | 41.1 | 40.8 |
| N25 | 0.0 | 14.5 |
| N30 | 0.0 | 0.0 |

### 2. Recipe of the Frozen Confection Product

The recipe of the frozen confection products are shown in table 2.

TABLE 2
Recipe of the frozen confection product, ice cream

| | Ice cream | |
|---|---|---|
| | Product A | Ice cream |
| Raw material used | (reference) | product B |
| Tap water | 66.0 | 66.0 |
| Fat composition No 1 | 6.0 | |
| Fat composition No 2 | | 6.0 |
| Skimmed milk powder | 3.5 | 3.5 |
| Whey protein concentrate | 2.7 | 2.7 |
| Sugar | 9.0 | 9.0 |
| Glucose - fructose syrup | 12.0 | 12.0 |
| Stabilizer | 0.6 | 0.6 |

### 3. Preparation of the Frozen Confection Product, Ice Cream

The fat was placed in the oven (oven used is a Memmert, FED 720) the day before making the ice cream. The fat was heated at a temperature of 65° C. Then, on the day of preparing the ice cream, all powders (of the recipe) were weighed and blended in a plastic bag. The water was heated to a temperature of 70° C. and was added into a bucket of 25 L. The blended powder was added into the water and mixed using a typhoon high shear mixer for 1 minute at 1500 rpm. Furthermore, the glucose-fructose syrup and the stabilizer (if liquid) were added into the liquid mix and mixed for 1 minute at 1500 rpm. Lastly, the molten fat composition was added on top and blended under high shear using a typhoon high shear mixer for 10 minutes at 1500 rpm. The thus obtained homogenous mixture was subjected to a heat treatment, homogenization & cooling using a GEA TDS 00A1847. The heat treatment was done at 86° C. for 30 seconds, followed by a homogenization at 180+30 bars and subsequent cooling at 10° C. The mixture was collected in sterilized 25 L buckets and closed with a lid. The buckets were transferred to a fridge at 5° C. and subjected to an aging for 18 hours. After the 18 hours, the mixture was frozen and aerated using a Tetra Hoyer KF 80 continuous freezer. The mixture was frozen to −6° C. and aerated with a target of 100% overrun. The thus obtained frozen ice cream was filled aseptically in plastic pots of 1000 ml & 250 ml and quickly cooled in a Koma KCF-15 blast freezer at −40° C. for 4 hours to harden and to complete crystallization. After 4 hours, the pots were transferred to final storage in a freezer at −18° C.

### 4. Evaluation of the Frozen Confection Product, Ice Cream

### Measuring the Melting Profile of the Ice Cream Products.

2 balances (Mettler Toledo New Classic MF ML2001) alongside the Mettler Toledo easy service/application controller software were used to simultaneously determine the melting speed of different ice cream products at room temperature (20° C.).

Ice cream product A in a 250 ml pot was transferred in a freezer overnight at a temperature of −20° C. Before the test, O-shaped holders were attached to a metal rod above the balances. On these holders metal grids were installed to allow the molten ice cream product A to run through. Furthermore, plastic containers were put on top of the balances to collect the molten ice cream product A and allow the amount to be weighed and registered by the software. Ice cream product A was then removed from the freezer and the weight of the plastic pot & ice cream is noted down. The plastic pot was then removed by using a knife to remove the bottom of the pot and then along the side of the plastic to demold ice cream product A onto the grid. The empty plastic pot was weighed to know the adjusted weight of ice cream product A (pot+ice cream product A−pot=absolute weight ice cream product A). This procedure was repeated for ice cream product B. After all ice cream products are put on their subsequent grids, the procedure is started through the software. Every 10 seconds, the software registered the weight from the balances and the value was stored. The procedure was completed when all ice creams were melted or after 180 minutes.

TABLE 3
Melting profiles.

| | Ice cream | Ice cream |
|---|---|---|
| | Product A | Product B |
| Time (min) for Start | 25 | 23 |
| melting | | |
| Time (min) for | 45 | 39 |
| melting 10 g | | |
| Time (min) for | 61 | 55 |
| melting 30 g | | |
| Time (min) for | 84 | 81 |
| melting 60 g | | |

The Ice cream Product B has very similar melt down properties compared to Ice cream Product A, despite the difference in the Solid Fat content of the 2 vegetable fats.

Sensory Evaluation of Different Fat Ingredient Source within Milk Ice Cream

For the sensory evaluation an external trained panel with 9-12 panelists have been used. The samples were tasted in 4 repetitions. For the serving procedure the samples were randomized with a 3-digit code and as quantity 1 jar of 120 ml frozen ice cream with a temperature of −13° C. served. On the testing protocol: the samples are swallowed and there was a break of 2 minutes between the samples. The order of serving was randomized and there were 2 products in one session evaluated. The methodology has a 95% confidence level for the comparison.

Ice Cream Product B has received better scores for Ice cream Taste, Dairy Notes, Fullness and Balance.

Product B was qualified with a more Ice cream taste vs. Product A. Ice Cream Product B showed for the Texture-Mouthfeel Descriptors better results on Density and Viscosity/Thickness which contributes to Fullness of the Ice cream Product. No Off- & Aftertaste or afterfeel attributes have been detected for Product B.

1. A frozen confection product comprising protein, sweetener, emulsifier, stabilizer and fat and the fat is consisting of interesterified lauric fat, and the frozen confection product is comprising:
2.0 to 10 wt % fat
0.5 to 4 wt % protein
10 to 30% sweetener
0.1 to 1 wt % emulsifier, and
0.1 to 1 wt % stabilizer,
based on the weight of the frozen confection product.

2. The frozen confection product according to claim 1 wherein the fat has a fatty acid moiety content with a carbon chain length of C12:0 of more than 20% based on total weight of the fatty acid moiety.

3. The frozen confection product according to claim 1 wherein the fat has a solid fat content at 10° C. of up to 75 wt. % and at 25° C. of more than 10 wt %.

4. The frozen confection product according to claim 1 wherein the lauric fat of the interesterified fat is selected from coconut oil, coconut stearin, palm kernel oil, babassu oil, cohune oil, tacum oil and cuphea oil, hydrogenated coconut oil, palm kernel oil, fully hydrogenated palm kernel oil, palm kernel stearin, hydrogenated palm kernel stearin, palm kernel olein, fully hydrogenated palm kernel olein, or a mixture of two or more thereof.

5. The frozen confection product according to claim 1 wherein the interesterified lauric fat is interesterified coconut oil.

6. The frozen confection product according to claim 1 wherein the frozen confection product is selected from ice cream, frozen custard, ice milk, frozen yogurt, sherbet, and water ices, mellorine, frozen dairy desserts for special dietary purposes, dairy dessert bars.

7. The frozen confection product according to claim 1 wherein the frozen confection product is selected from ice cream and mellorine.

8. A process for preparing the frozen confection product according to claim 1 and the process is comprising:
Blending interesterified lauric fat with frozen confection product ingredients different from fat,
Freezing the blend.

9. Use of interesterified lauric fat to improve sensory properties of a frozen confection product, and wherein the interesterified lauric fat is present in the frozen confection product in an amount of 2 to 10 wt. % based on the weight of the frozen confection product.
